(19) United States
(12) Patent Application Publication
(10) Pub. No.: US 2007/0102359 A1
(43) Pub. Date: May 10, 2007

(54) Treating produced waters

(76) Inventors: John A. Lombardi, Boulder, CO (US); James Tranquilla, New Brunswick (CA); Larry J. Buter, Highlands Ranch, CO (US); William Hawthorne, Thornton, CO (US); Kenneth A. Brunk, Centennial, CO (US); Gary J. Herbert, Thornton, CO (US); Dennis H. Green, Arvada, CO (US)

Correspondence Address: SHERIDAN ROSS PC, 1560 BROADWAY, SUITE 1200, DENVER, CO, 80202, US

(21) Appl. No.: 11/413,345

(22) Filed: Apr. 27, 2006

Related U.S. Application Data
(60) Provisional application No. 60/675,775, filed on Apr. 27, 2005.
(60) Provisional application No. 60/696,000, filed on Jul. 1, 2005.
(60) Provisional application No. 60/774,689, filed on Feb. 17, 2006.

(51) Int. Cl. B01D 61/00

(52) U.S. Cl. 210/639; 210/641; 210/650; 210/758; 210/806; 210/764; 210/259; 210/202

(57) ABSTRACT

The present invention is directed to various sets of unit operations for treating aqueous effluents and logic for designing and effecting the treatment. The unit operations include stabilization of subterranean waters, sequential oxidation steps to alter selected target materials, oxidation to break up emulsions prior to removal of the emulsion components, and intense oxidation to break up difficult-to-remove organic target materials.

### CROSS REFERENCE TO RELATED APPLICATION

The present application claims the benefits of U.S. Provisional Application Serial No. 60/675,775, filed Apr. 27, 2005, entitled “Treatment for SAG-D Oil Field Produced Water and Method of Same”; U.S. Provisional Application Serial No. 60/696,000, filed Jul. 1, 2005, entitled “A Treatment for Oil and Gas Field Water, including “Flow-Back Fluid” Contaminated Produced Water, and Method for Operating Same,” and U.S. Provisional Application Serial No. 60/774,689, filed Feb. 17, 2006, entitled “Oil and Gas “Produced Water” Treatment and Method for Operating Same,” each of which is incorporated herein by this reference.

### FIELD OF THE INVENTION

The present invention relates generally to water treatment and specifically to the removal of oil, grease, emulsions, chemicals, polymers, and suspended and dissolved solid contaminants using membranes.

### BACKGROUND OF THE INVENTION

The production of aqueous and gaseous hydrocarbon commodities through boreholes from geologic repositories is typically accompanied by the production of waste drilling fluids and drilling fluid additives, formation waters, and, in the specific cases of thermal stimulation wells, the production of spent steam injection liquors. In all cases, the borehole-produced waters are organic- and inorganic-content contaminated relative to the water quality standards promulgated by potential surface users, including irrigators, potable water distributors, industrial steam producers and most other industrial use standards. These contaminated borehole waters are referred to as “oil-gas field produced” and “oil-gas field flow-back” waters and will be referred to hereafter in this document as a species of “produced” water.

Oil-gas field produced water is most often a blend of geologic formation water and surface water that has been injected into the formation during the processes of well-drilling, well-stimulation, or geologic formation conditioning, as for example by the injection of steam into a formation. The produced water from a single borehole can exhibit a wide range of oxidation-reduction potentials and dissolved solids contents relative to the mix of formation and introduced waters and the conditions of pressure of depth of burial and autonomic heating effects. Also, a wide range of soluble and insoluble organics and biota may be present in the produced water, again, as contributed by the geologic and introduced sources of the water. Also, there can be a wide variation on the ratio of contaminants present for any given borehole on a time basis, with time zero typically being that point in time where there is a massive injection-introduction of surface sourced water and contaminants; also called the point of “well stimulation.” At time zero, the introduced water, polymer and chemical contamination of the water is at its highest level, and, typically, the geologic source components of the contamination of the water is at its lowest level. With the passage of time the ratio of surface-sourced, introduced, contamination relative to geologic source contamination reverses itself in favor of the geologic source component.

Because they are contaminated, oil-gas field produced waters are not typically surface dischargeable, except as might be allowed by a special exemption. These exemptions are typical to the industry and are usually written around the concept of produced water discharge to evaporation ponds. This practice of produced water discharge to evaporation ponds has recently been identified to be “wasteful” both in regards of the potential benefits that might accrue to immediate, area adjacent, alternative uses of the water and the loss of productivity of land inundated by the evaporation ponds. For these reasons, there is social pressure to investigate the efficacies of the treatment of oil-gas field produced waters to the alternate beneficial end-use water quality standards of irrigation, human consumption and industrial processes.

The present-day economics of hydrocarbon production have enabled fields that are large volume, geologic source water producers to be brought on-line. In other cases, large water volume producing “heavy oil” reserves have been brought on-line by the use of introduced source, steam, injection techniques. In other cases, large volume water production fields have been created from “tight” hydrocarbon containing geologic formations by the use of water injection “hydro-fraccing” (hydraulic-fracturing).

These increased water volume production fields have exacerbated surface land use and water waste issues. For some fields, the surface pond discharge option has been legislatively obviated because the large land surfaces required for the ponds led to a public outcry and loss of a social-license-to-operate, except by the adoption of more natural resource conservative methods. In a case like this, the first response of the industry is to defuse the “land use” conflict by deep-well disposal of the offending contaminated water. Although the deep-well disposal method managed the negative land-use aspects of large area evaporation pond construction, it did not negate criticism of the “wasting” of water resources. While the industry contends the ground water brought to the surface in its operations is returned to the ground water state by the act of underground disposal, the public sees the deep-well process as a loss of a precious surface water asset.

While this debate continues, an additional factor has entered the production equation in the form of the high cost to transport the water to the deep-well sites. This water transportation cost has essentially doubled over the course of the last decade due to the global tightening of petroleum product supplies and attendant fossil-fuel price increases. Because the tightened petroleum product supply is predicted to be endemic, the oil-gas industry has determined that the time of borehole-produced water treatment and waste minimization is the path both to increased hydrocarbon production profitability and an improved social profile relative to the land use and water conservation issues.

While the oil-gas industry has recognized the need for bore-produced water purification, it has had few economically viable and effective water treatment technologies from which to choose. By way of example, oil and gas field “produced” waters are typically dissolved solids laden and classified as “brackish” waters. The treatment of the brackish well-bore water produced by wells that have been stimulated, especially those wells that have been fracced, have been refractory to conventional pure water extraction processes, specifically the method of membrane “reverse osmosis” desalinization. The refractoriness of the water has been manifest as a tendency of the water to “foul” as in the formation of a membrane surface coating that retards the membrane permeate production process and frustrates the pure water production intent of the process. When treating the well-bore water from stimulated wells, the membrane process interfering surface coating appears to form immediately upon water-membrane contact. Because oil and gas field produced waters from non-stimulated wells is non-fouling relative to the “immediate coating formation” phenomena of the stimulated well waters, the fouling is deduced to be a result of the stimulation process, specifically the chemical additions that are typically used as part of the “frac” process. In the frac process, sand is forced under pressure into cracks that are pressure induced into the oil or gas production formation. The sand is carried deep into the cracks by a viscous gel that is typically made by a mix of water and “guar flour” (ground endosperms of Cyanopsis tetragononoloba: the flour is 85% water soluble and called guaran, and the water soluble components are principally galactose 35%, 63% mannose and 5-7% protein). The gel is “broken” or “thinned” to allow the release of sand at the sand's point of furthest ingress into the formation crack; the breaking process is usually affected by an “enzyme breaker.” The broken gel is referred to as the “broken organic” component of the “flow back water.” Hereafter, the well stimulation additive of interest to the membrane fouling process will be referred to as “broken polymer,” or “polymer.”

By way of example, a mechanical vapor recompression evaporation system known as the Aqua Pure™ system uses a filter for solids removal followed by chemical treatment to combat scaling in a downstream evaporator stage and to remove dissolved gas. The evaporator stage forms, through vaporization and condensation, a water product of high purity and a brine reject stream that includes hydrocarbons, frac fluids, salts, and the like. The Aqua Pure™ system has a relatively low throughput at a relatively high cost.

### SUMMARY OF THE INVENTION

These and other needs are addressed by the various embodiments and configurations of the present invention. The present invention is directed generally to the treatment of aqueous feedstreams including one or more organic and inorganic constituents. In a particularly desirable application, the invention is used to form a purified water product from produced water.

In a first embodiment of the present invention, a water treatment approach includes the steps of:

(a) providing a stabilization operation to aerate a selected feed water, the selected feed water having been withdrawn from a subterranean formation;

(b) when the selected feed water contains at least a first selected concentration of an emulsion, providing an oxidation operation to decompose at least some of the emulsions;

(c) when the selected feed water contains at least a second selected concentration of an immiscible organic compound, providing a macro-particle removal operation (such as flotation) to remove at least some of the immiscible organic compounds; and

(d) when the selected feed water contains at least a third selected concentration of a miscible organic compound, providing an adsorption operation to remove at least some of the miscible organic compounds.

The approach can be used to design, fabricate, and/or operate a water treatment system. The approach is particularly useful for purifying produced water, such as from hydrocarbon extraction operations.

In yet another embodiment, a treatment method includes the steps of:

(a) receiving a produced water from a subterranean formation, the produced water comprising at least one chemical constituent that is unstable at the surface;

(b) aerating the produced water with a molecular oxygen-containing gas until a selected degree of stability of the produced water has been realized; and

(c) thereafter further treating the produced water to remove one or more selected target materials.

The embodiment provides a technique to accelerate the rate at which the produced water is at equilibrium with ambient conditions at the surface. The conditions include temperature, pressure, and atmospheric gas composition. By providing a more stable solution, the target materials will be less likely to decompose during treatment into unexpected species that complicate water purification.

In yet another embodiment, a treatment method includes the steps of:

(a) receiving an aqueous feed derived from extracting hydrocarbons from a subterranean formation;

(b) intensely oxidizing at least some of the aqueous feed to decompose a selected organic material, the intensely oxidizing step using a chemical oxidant having an oxidizing potential of more than about 2V (standard reduction potential (“SRP”)); and

(c) further treating the aqueous feed after step (b).

This step can decompose difficult-to-treat organic materials, such as guar gum and polyacrylamides. It can be performed using high energy radiation, such as ultrasound and ultraviolet energy.

In yet another embodiment, a treatment method includes the steps of:

(a) receiving an aqueous feed derived from extracting hydrocarbons from a subterranean formation;

(b) first mildly oxidizing the aqueous feed to decompose any emulsions in the aqueous feed, wherein the mildly oxidizing step uses a chemical oxidant having an oxidizing potential of no more than about 2V (SRP);

(c) thereafter intensely oxidizing at least a portion of the aqueous feed to decompose a selected organic material, the intensely oxidizing step using a chemical oxidant having an oxidizing potential of more than about 2V (SRP); and

(d) further treating the aqueous feed after step (c).

The use of dual oxidation steps can provide a relatively inexpensive way to effect decomposition of selected target materials. The mild oxidation step is generally less expensive than intense oxidation. Thus, readily oxidized species can be oxidized in mild oxidation while less readily oxidized species, such as guar gum and polyacrylamides, can be oxidized in intense oxidation. This staged approach can reduce the amount of the more expensive intense oxidants needed to effect intense oxidation.

The present invention can provide a number of advantages depending on the particular configuration. The invention can provide a relatively inexpensive and high capacity process to produce a water product of high purity. The water product can be used in a wide variety of applications, including recycle to well drilling, preparation, and production operations and agricultural and industrial applications.

In another embodiment, the present invention includes a system for treating an aqueous feed, comprising:
(a) an aeration vessel to contact the aqueous feed with a molecular oxygen-containing gas;
(b) a flotation vessel located downstream of the aeration vessel to remove, from at least a portion of the aqueous feed, a first set of immiscible organic target materials;
(c) a clarifier located downstream of the flotation vessel to remove, from at least a portion of the aqueous feed, suspended solids;
(d) an absorbent located downstream of the flotation vessel to remove a second set of miscible organic target materials;
(e) at least one of a microfilter and ultrafilter located downstream of the absorbent to remove, from at least a portion of the aqueous feed, a third set of target materials; and
(f) at least one of a nanofilter and hyperfilter located downstream of the at least one of a microfilter and ultrafilter to remove, from at least a portion of the aqueous feed, a fourth set of target materials.

In one embodiment, the system further includes an oxidation vessel, positioned between the aeration vessel and flotation vessel, to decompose any emulsions in at least a portion of the aqueous feed.

In another embodiment, at least one of a microfilter and ultrafilter may include an ultrafilter and a microfilter positioned upstream of the ultrafilter. Alternatively, at least one of a nanofilter and hyperfilter includes a hyperfilter and a nanofilter positioned upstream of the hyperfilter.

In still another embodiment, the system further includes an intense oxidation vessel, positioned between the absorbent and the at least one of a microfilter and ultrafilter, to decompose selected organic materials, the intense oxidation vessel including at least one of an ultrasonic and ultraviolet radiation source to irradiate at least a portion of the aqueous feed and generate free hydroxyl radicals.

These and other advantages will be apparent from the disclosure of the invention(s) contained herein.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The above-described embodiments and configurations are neither complete nor exhaustive. As will be appreciated, other embodiments of the invention are possible utilizing, alone or in combination, one or more of the features set forth above or described in detail below.

### BRIEF DESCRIPTION OF THE DRAWINGS

FIG. 1 depicts a set of unit operations according to an embodiment of the present invention;

FIG. 2 depicts logic according to an embodiment of the present invention for configuring sets of unit operations to treat a selected suite of target materials in an aqueous effluent;

FIG. 3 depicts logic according to an embodiment of the present invention for configuring sets of unit operations to treat a selected suite of target materials in an aqueous effluent;

FIG. 4 depicts logic according to an embodiment of the present invention for configuring sets of unit operations to treat a selected suite of target materials in an aqueous effluent;

FIG. 5 depicts logic according to an embodiment of the present invention for configuring sets of unit operations to treat a selected suite of target materials in an aqueous effluent;

FIG. 6 depicts a process configuration according to an embodiment of the present invention;

FIG. 7 depicts a process configuration according to an embodiment of the present invention; and

FIG. 8 depicts a process configuration according to an embodiment of the present invention.

### DETAILED DESCRIPTION

The process of the present invention is a produced water treatment method in which industrial process feed waters are defined and purified waters generated by a sequence of treatments that, in aggregate, define a “baseline water treatment” train for the removal of contaminants and production of beneficial end use waters. End use waters are generally in compliance with federal clean drinking water standards and are used for a wide variety of uses including revegetation of well sites, fire protection, drilling and workover operations, process cooling, road maintenance, stream bed makeup and groundwater aquifer recharge, landscape irrigation of golf courses, city parks and the like, livestock watering, wildlife habitats, and crop irrigation. All or parts of the treatment train can be used on an as-required and optional basis to achieve defined water quality standards. The process of the present invention can integrate the evolving social demand for conservation of resources with the corporate economic need of the industrial producer to exploit the natural resource base using known, commercially available, technologies in this time of changing contaminant definition.

The present invention teaches the treatment of contaminated water by a series of unit processes and the decontamination of the water relative to a set of promulgated standards for, optionally, the production of irrigation water, the production of water for industrial reuse, or for the production of water supply quality water. The invention describes the water treatment as decontamination-specific relative to the baseline set of unit processes and the optional use of all or part of the baseline set of unit processes. The invention teaches the removal of contaminants as denoted by a statement of water decontamination goals, but the use of the word contaminant is not construed to identify the removed organic, inorganic, or biological substance to be valueless. For the purpose of illustration, the invention can be described in terms of the “flow-back” and “produced” waters that are borehole co-produced by the extraction of hydrocarbons from geologic repositories. The use of oil and gas field “produced” water is exemplary of water that is described to be contaminated, as with oil, relative to a surface use, like crop irrigation, where the contaminant has a value greater than the water that is produced by the present invention, and is illustrative of the use of, but not limited to, the baseline water treatment unit process sequence of the present invention, being employed on an as-required and process optional basis, for the treatment of paper-and-pulp industry waters where the recovery of, for example cellulose, is a paramount value, or the treatment of mineral contaminated waters where the recovery of, for example gold or copper or other metals, is a paramount value.

The following description of the present baseline water treatment unit process invention for the treatment of oil and gas borehole “produced” water is presented as exemplary and illustrative of a method that can be employed in similar manner to all types of contaminated water.

“Produced water” is generally a combination of formation water and introduced water and may refer to the water as removed from the subterranean formation or to any water derived therefrom by later processing, such as the aqueous by-product of hydrocarbon extraction operations. The introduced water is typically predominant when the produced water is in close time proximity to either the drilling of the well or the hydro-frac or steam-thermal stimulation of the well. The formation water is typically predominant at all other times.

In most cases, produced water is raised from depth through boreholes, as a co-product or by-product of the business of oil and gas extraction. This type of produced water has its origins in the geologic formations of oil and gas production. The combined effects of the pressure of burial of the water and the autonomic effects of temperature increase due to burial results in geologic formation waters that have an increased solvation power relative to surface ambient pressure-temperature water. The increased solvation power formation water interacts with the minerals and gas in the geologic unit and forms high dissolved mineral and gas content solutions. Some of the dissolved solids and gas components of these solutions are disproportionately high relative to their presence in lower salvation power, atmospherically exposed, surface water. Further, the high solvation power produced water is also typically contaminated with remnant well drilling and/or well stimulation chemicals, including biocides, lubricants, drilling mud and mud system polymer additives. The increased solvating power water raised from below with its load of dissolved inorganic minerals and contaminant organics becomes unstable as it transitions to low solvating power surface water and, because it coincidentally absorbs atmospheric gases and creates new organic and inorganic chemical species, solid compound precipitations and gas emissions occur spontaneously. Although a spontaneous process, the re-equilibration of the water may take months or years as the kinetics of the spontaneous processes of precipitation and off-gassing for specific inorganic and organic compounds is different.

In a typical application, the produced waters include a number of contaminants or target materials. Produced waters can include, for example, from about 10 to about 1000 ppm insoluble crude oil residuals (e.g., dispersed oil droplets), from about 0.001 to about 100 ppm soluble hydrocarbons (such as benzene, toluene, and other dissolved aryl and alkyl groups and organic acids), from about 1,000 to about 10,000 ppm monovalent and multivalent metal salts (e.g., salts of iron and other metals from IA and IIA of the Table of Periodic Elements, such as carbonates, nitrates, chlorides, fluorides, phosphates, sulfides, and sulfates), from about 0.01 to about 1 vol. % solid, finely sized particles (such as clay and particulate silicate formation fines), from about 0.001 to about 100 ppm colloids (e.g., colloids of immiscible organic acids, such as humic acid), from about 0.001 to about 200,000 ppm miscible organic compounds other than hydrocarbons (e.g., polymeric and non-polymeric gelling agents, well stimulants such as guar and polyacrylamides, surfactants, and polymeric lubricants), microbes (such as viruses and bacteria), from about 1 to about 100,000 ppm emulsions, and from about 1 to about 100,000 ppm dissolved gases, such as hydrogen sulfide.

As used herein, a “colloid” is a finely divided, solid material, which when dispersed in a liquid medium, scatters a light beam and does not settle by gravity, such particles are usually less than 0.02 microns in diameter. Some drilling fluid materials become colloidal when used in a mud, such as bentonite clay, starch particles and many polymers. Oil muds contain colloidal emulsion droplets, organophilic clays and fatty-acid soap micelles. An “emulsion” is a dispersion of one immiscible liquid into another through the use of a chemical that reduces the interfacial tension between the two liquids to achieve stability. Two emulsion types are used as muds: (1) oil-in-water (or direct) emulsion, known as an “emulsion mud” and (2) water-in-oil (or invert) emulsion, known as an “invert emulsion mud.” The former is classified as a water-base mud and the latter as an oil-base mud.

Apart from the potentially harmful effects on the environment, many of these target materials can foul, abrade, perforate, or otherwise damage membranes. Known foulants include soluble oil residuals, soluble organic hydrocarbons, soluble iron and similar metals, precipitating mineral hardness, elemental sulfur, and treating chemical residuals. Known abrasive materials include insoluble iron and similar metals. These materials are therefore typically removed before membrane separations are performed.

The salinity and pH of produced waters varies widely from location-to-location, ranging from very low salinity to saturated salt solutions containing approximately 300,000 ppm total dissolved solids (TDS). Typically, the salinity will be less than about 35,000 ppm TDS, or the equivalent of seawater TDS, and the pH will range from about pH 5 to about pH 9.

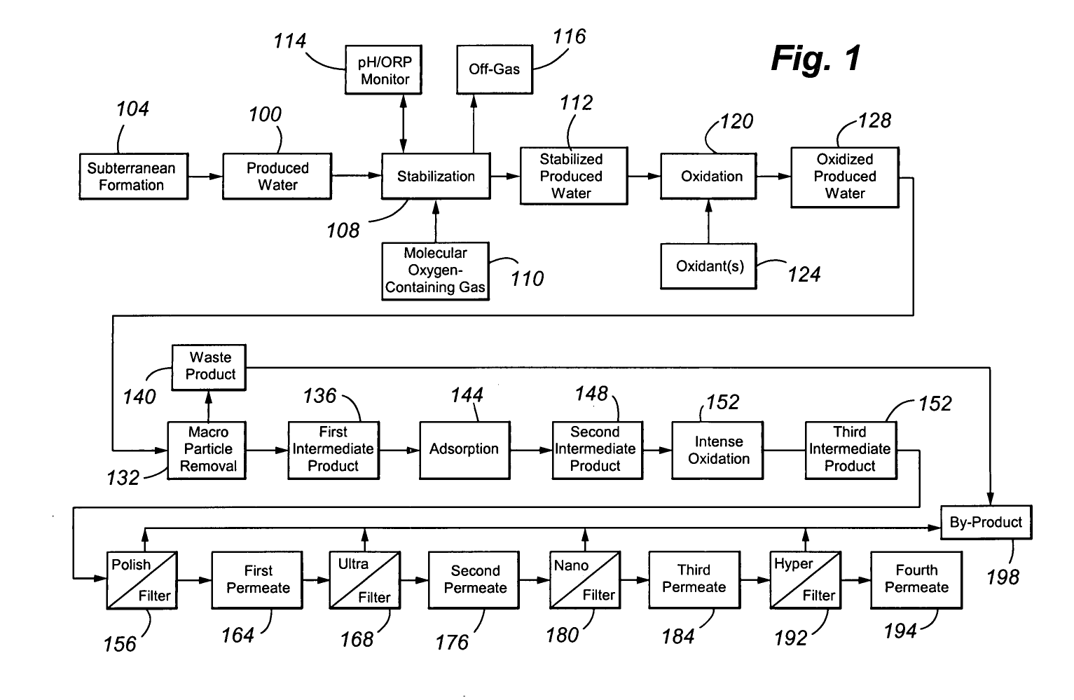

Referring now to FIG. 1, produced water 100 from a source, such as a subterranean oil, coal, and/or natural gas reservoir 104, is inputted into a unit process (not shown) to recover hydrocarbons and form a hydrocarbon product (not shown) and aqueous produced water product (not shown) The first stage in any produced water treatment is the separation of hydrocarbon from the water by the owner-operator of the well bore. This separation is typically by an “oil-water separator” if the resource is liquid and by a “gas knock-out box” if the resource is gaseous. These primary hydrocarbon resource recovery processes are not considered to be a part of the present invention, though the possibility of using either or both the “separator” and the “knock-out box” as scavenger hydrocarbon recovery tools in the downstream produced water treatment invention is described in this document. The temperature of the aqueous by-product typically is at least about 40° F, and more typically ranges from about 40° F to about 90° F.

In an optional first (stabilization) step 108, the aqueous product derived from the produced water 100 is subjected to aeration with a molecular oxygen-containing gas 110, such as air, to change the product's environment from reducing to oxidizing and thereby oxidize the product. Aeration is performed for a time period sufficient to create a solution that is substantially stable, or no longer changing at more than a determined rate over a selected period of time. Typically, the product is deemed to be stable when it is close to chemical and dissolved gas contents equilibrium with the surface, molecular oxygen-containing, atmosphere. Aeration can cause target materials to volatilize or be oxidized to insoluble compounds that can be separated by techniques, such as skimming, filtering, and/or settling. Through aeration, preferably at least most of the soluble iron and manganese ions and compounds in the product are converted into insoluble compounds.

Aeration by air-sparging, dissolved-oxygen enriched-gas injection, air induction, solution atomization, solution cascading, and solution shearing to induce air are the typical commercial means of aerating the solution. The water stabilization process is deemed to be completed when the pH and ORP (oxidation-reduction-potential) of the product as measured during aeration by the monitor 114 has leveled-out. The pH of the fully aerated or stabilized produced water 112 typically ranges from about pH 6 to about pH 8.

When the produced water product has a significant dissolved gas component this gas can be driven from the solution by one of the more vigorous aeration options to effect what is called “gas stripping” and produce an off-gas 116. Due to potential evolution of harmful gases, such as sulfur oxides, hydrogen sulfide, carbon oxides, and nitrous oxides, aeration may be performed in a sealed vessel to effect evolved gas collection. A gas purification system (not shown), such as a scrubber, activated carbon adsorption, and/or a vapor recovery unit, can be used to clean up the evolved gas before discharge into the environment. Alternatively, gas evolution may be performed before aeration by holding the by-product in a sealed vessel before aeration.

In the next optional step 120, the stabilized produced water 112 is treated by further oxidation to break up organic-and inorganic-suspended solid emulsions, including hydrocarbon emulsions, and form an oxidized produced water 128. The further oxidation is typically done using chemical oxidants 124 having an oxidizing potential of about 2V (SRP) or less. Suitable oxidants include hydrogen peroxide, permanganate, chloride compounds, chlorine, chlorine dioxide, hypochlorous acid, chlorine gas, hypobromous acid, molecular oxygen, bromine, hypoiodous acid, hypochlorite, chlorite, iodine, and mixtures thereof. The oxidants 124 are normally used in concentrations ranging from about 0.01 to about 15 g/l.

The emulsions are typically a mixture of liquid hydrocarbon, organic and polymer, and suspended solids. The suspended solids component of the water is composed of residual drilling mud clays, geologic formation solids and, because the step follows the “aeration” first step of the present invention, aeration process-created iron and manganese suspended solids. For example, the presence of organics and emulsions is most pronounced in flow-back waters, e.g., the waters that are recovered from the borehole immediately after a well hydro-frac.

The method of chemical treatment of the water to break emulsion is very often coincidentally biocidal, for example as by the use of oxidants, such as chlorine, peroxide or chlorine dioxide, having biocidal properties. For many produced waters, the biocidal treatment of the water can be important to prevent the bio-fouling of the membranes, and, if the chemical emulsion breaker employed at this step in the process is not biocidal or not sufficiently biocidal to kill the biota in the water, a separate step of biocide addition is typically executed before the continued treatment of the water.

Next, optional step 128 removes at least most of the suspended solids and organic residuum, including biota remains, greases, and hydrocarbon lubricants, from the oxidized produced water 128 and forms a first intermediate product 136 and a waste product 140 including at least most of the removed materials. The removal of suspended solids by particle filtration using a nonionic filter (including but not limited to filter cloth, diamataceous earth filters, or polypropylene filters) having a preferred pore size in the range of from about 100 to about 1,000,000 angstroms, with optional intermediate coagulation-flocculation additive treatments, and/or by the use of clarifiers with or without the use of seed lime, soda ash, or other clay-type seed minerals. The filter removal of immiscible broken polymer and hydrocarbons may be conducted by any suitable technique, as by nut bed filtration. Chemical additives, such as iron sulfate and aluminum chlorohydrate, may be used to coagulate and depress solids. Subsequently, the organic-hydrocarbon may be removed by the use of clarifiers and/or by the use of dissolved-air-flotation and the skim removal of floated organic residuum and hydrocarbons. As described above, this step in the process of the present invention may be affected by a multiplicity of inter-step filtration and clarification exercises.

In this step 132, it is preferred that at least most, more preferably at least about 99%, and even more preferably at least about 99.9%, of the macro and micro particle range particulate materials having a size of at least about 10 angstroms, and even more preferably of at least about 100 angstroms, are removed from the oxidized by-product to form the first intermediate product 136. The pH of the by-product solution during this step typically ranges from about pH 4 to about pH 10.

In optional step 144, preferably at least most, and even more preferably at least about 99.9% of the dissolved hydrocarbons, some types of organic acids, some types of surfactants, and some types of polymers are removed from the first intermediate product 136 to form a second intermediate product 148. The concentration of the dissolved hydrocarbons in the second intermediate by-product is typically no more than about 0.0001 ppm. The adsorption is preferably effected using an absorbent, preferably microporous media, such as zeolites, activated carbon filter media, organo clay, polypropylene, and/or other types of microporous media. Preferably, the pH of the first intermediate by-product solution during this step ranges from about pH 4 to about pH 10.

In optional step 152, any remaining dissolved hydrocarbon and other organic components of the second intermediate product 148 are intensely oxidized to form a third intermediate product 152. For example, in one configuration at least most of the guar gum carbohydrate and polyacrylamide structures in the water are removed by intense oxidation through exposure to a chemical oxidant having an oxidizing potential of more than 2V (SRP). Suitable chemical oxidants include hydroperoxyl radicals, hydroxyl radicals, and ozone radicals. Hydroxyl radicals are preferably generated by high energy ultrasonic energy exposure, photocatalytic (UltraViolet or UV) radiation exposure, and/or the addition of chemical additives, such as hydrogen peroxide or ozone. The desired result is to create hydroxyl radicals or ions in solution to attack and chemically oxidize the dissolved organic compounds. Typically, most, if not all, of the long chained organic compounds oxidized into their gaseous oxidic byproducts, such as water and CO₂. The pH of the third intermediate product 152 typically ranges from about pH 4 to about pH 10.

In the next optional step, the third intermediate product 152 is passed through a polishing filter 156 to form a first retentate 160 and first permeate 164 and to remove, in the first retentate, filtration treatment residuum in the macromolecular range. The polishing filter 156 is preferably a nonionic microfilter having a pore size smaller than that of the particle filter and preferably ranging from about 1,000 to about 20,000 angstroms.

In the next optional step, the first permeate 164 is passed through an ultrafilter 168 to form a second retentate 172 and second permeate 176 and remove, in the second retentate, any remaining filtration treatment residuum in the molecular range. The ultrafilter is preferably a nonionic filter having a pore size smaller than that of the microfilter and preferably ranging from about 100 to about 1,000 angstroms.

The use of a polishing membrane microfilter followed by a polishing membrane ultrafilter removes any remaining residuum such as carbon black fines, biota (alive or dead), colloidal silica, and colloidal iron. Preferably, the first and second retentates collectively include at least most and even more preferably, at least about 99% of the filtration treatment residuum in the macro molecular and molecular ranges.

In the next optional step, the second permeate 176 is passed through a nanofilter 180 to form a third permeate 184 and retentate 188 and remove, in the third retentate, at least most, and even more preferably at least about 90%, of the target materials in the lower molecular range and higher ionic range. The target materials removed in this step are typically multivalent dissolved solids ions and oxidation treatment residuum. The common materials removed in the third retentate are multivalent metal salts. As will be appreciated, nanofilters use a combination of charge distribution and pore size to remove materials in the retentate. Commonly, the third permeate includes at least most of the monovalent ions while the third retentate includes at least most of the multivalent ions.

In the next optional step, the third permeate 184 is passed through a hyperfilter 192, or reverse osmosis membrane, to form a fourth permeate 194 and retentate 196 and remove, in the fourth retentate, at least most, and preferably at least about 99%, of the target materials in the lower ionic range. The target materials removed in this step are typically monovalent dissolved solids ions and oxidation treatment residuum. The common materials removed in the third retentate are monovalent metal salts. Thus, the hyperfilter desalinates the third permeate. As will be appreciated, hyperfilters are ionic filters using a combination of charge distribution and pore size to remove materials in the retentate. Commonly, the fourth permeate is substantially free of the target materials noted above.

The ultrafilter 168, nanofilter 180, and hyperfilter 192 membranes can be any suitable membrane. Examples include crossflow spiral-wound membranes and hollow fiber membranes.

As will be appreciated, anti-scalants and anti-foulants can be added to the various permeates upstream of membrane filters to inhibit fouling of the downstream membranes. As will be further appreciated, the ordering of the various optional steps may be different depending on the application.

The pH of the permeate may be adjusted before hyperfiltration or nanofiltration so that dissolved silica is removed by filtration and before hyperfiltration to remove boron. When silica is present with one or more of aluminum, magnesium, iron, and calcium dissolved silica can become a silicate, which can be difficult to remove.

The fourth permeate 194 is in compliance with most state and federal drinking water standards. The various retentates contain at least most of the target materials and may be deep well injected or collectively or individually recycled to selected unit operations in the process. Typically, the fourth permeate 194 represents from about 60 to about 90 vol. %, the first retentate 160 from about 2 to about 5 vol.%, the second retentate 172 from about 2 to about 5 vol.%, the third retentate 188 from about 5 to about 15 vol.%, and the fourth retentate 196 from about 5 to about 15 vol.% of the produced water product. The waste 140 and first, second, third, and/or fourth retentates may be combined to form a by-product 198.

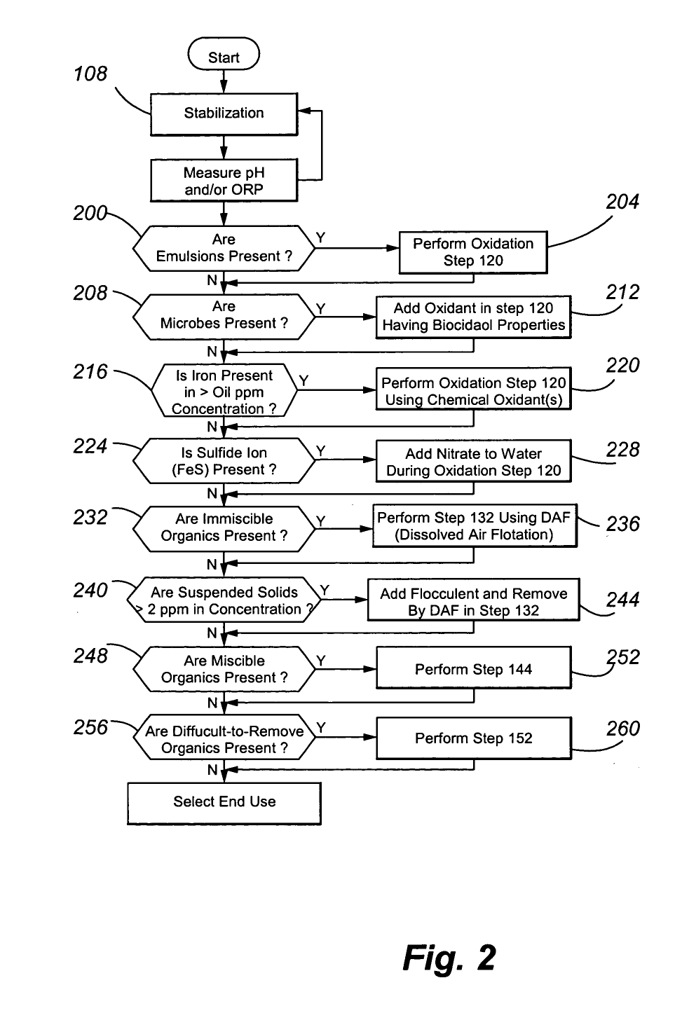

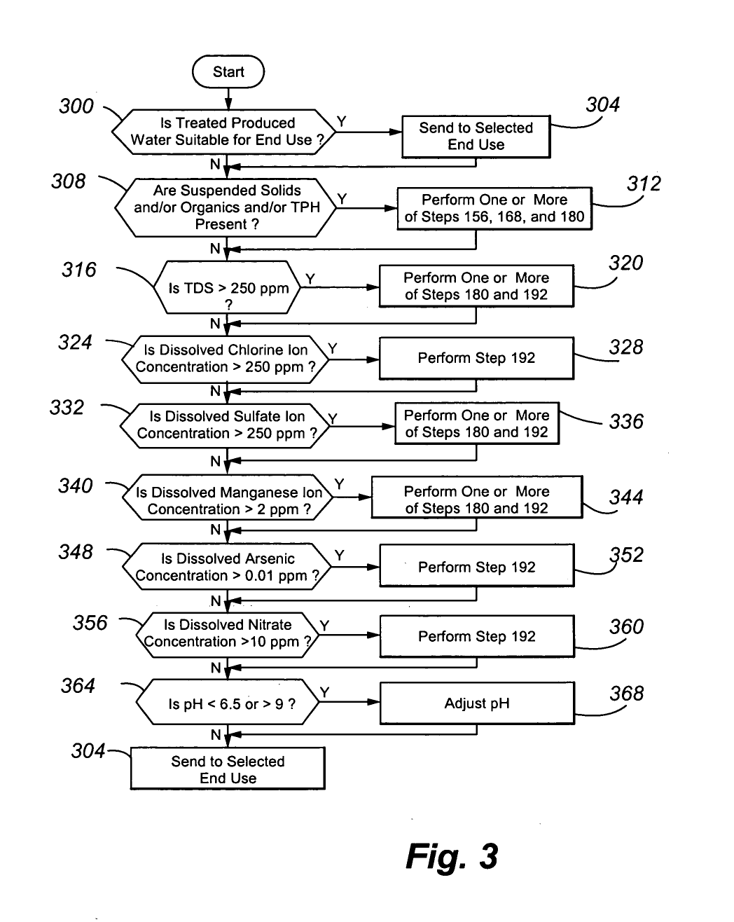

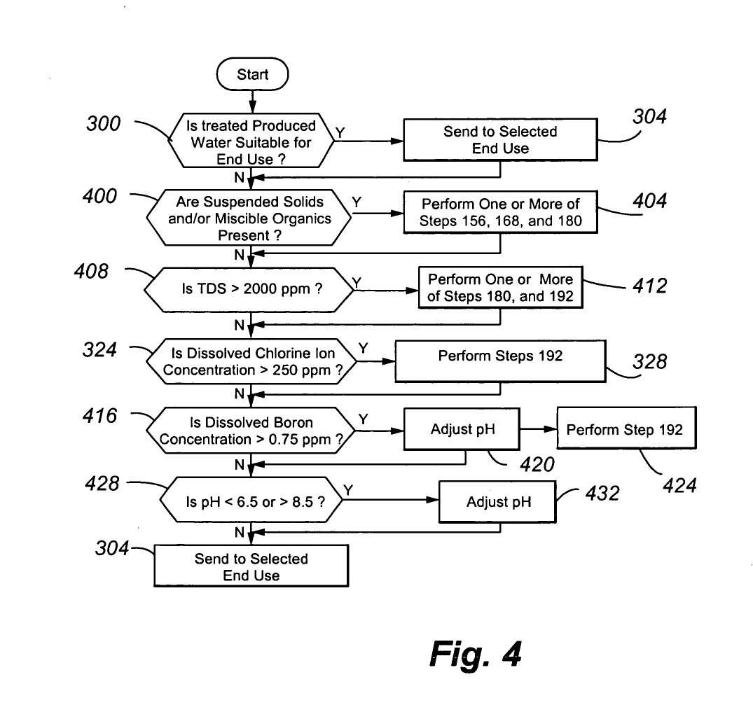

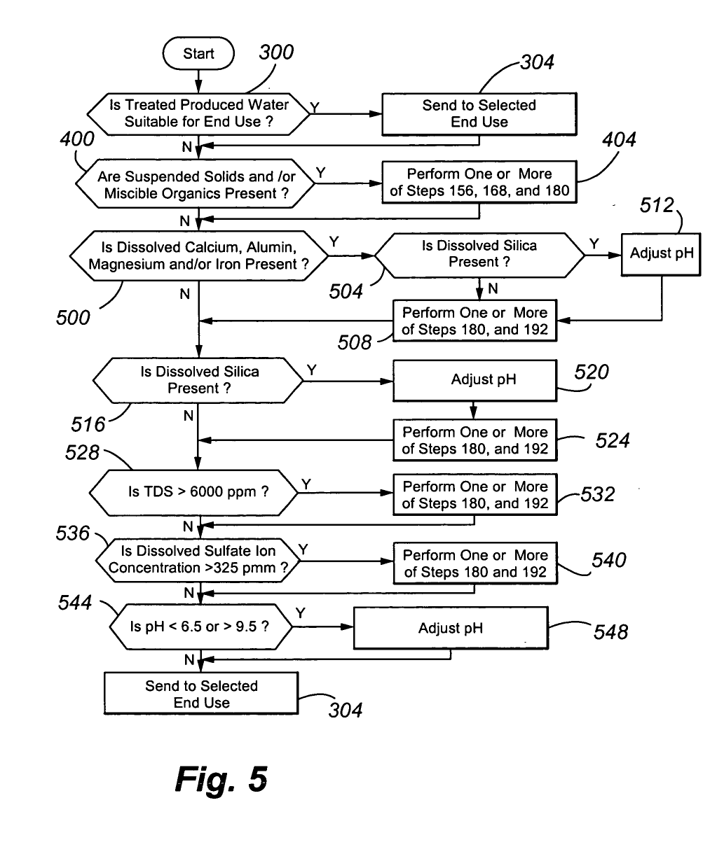

With reference to FIGS. 2-6, automated operational and/or process design logic will be discussed. The logic is premised upon analyzing the produced water, or the produced water product derived from the produced water, to identify the target materials present in the water. Due to chemical changes in the water, the water is preferably analyzed after it is stabilized by aeration, as in optional step 108 above. In one configuration, real time or near real time analysis of the water composition/conditions is performed, and a control feedback circuit alters operating parameters for selected unit operations and/or opens and closes valves to direct the water to appropriate unit operations to effect removal of one or more selected target materials. The latter configuration is particularly important where the composition of the produced water varies over time and/or the treated water is used for different end uses. Following analysis, the end use of the purified water must also be identified to understand which of the target materials must be removed and/or reduced in concentration to levels required by the selected end use. With this in mind, FIG. 2 shows the logic used in selecting a set of optional steps of FIG. 1 to remove selected target materials before micro-filtration; FIG. 3 shows the logic used in configuring a water treatment process for producing water to be supplied for non-industrial and non-agricultural end uses; FIG. 4 shows the logic used in configuring a water treatment process for producing water to be supplied for agricultural use; and FIG. 5 shows the logic used in configuring a water treatment process for producing water to be supplied for industrial use.

Referring to FIG. 2, the produced water is aerated in optional step 108 to stabilize the water. During aeration, the pH and Oxidation-Reduction-Potential or ORP is measured and monitored by the monitor 114. When the ORP rate of change over a selected period of time is within a selected amount, typically no more than about + or −10% over a time period of about 10 minutes, the water is deemed to be stable, and it is next determined in decision diamond 200 whether there are any emulsions present in the stabilized produced water. If so, emulsion breaking in optional step 120 above is performed in box 204. Next in decision diamond 208, it is determined whether living microbes are present in the stabilized produced water. When microbes are present (typically characterized by a microbial count greater than zero), a biocide, such as chlorine, hypochliorite, copper sulfate, or chlorine dioxide, is added, in step 120, to kill the microbes (box 212). The biocide is typically efficacious in the range of from about 1to about 5 ppm. In decision diamond 216, it is next determined whether the stabilized produced water contains more than about 0.1 ppm dissolved iron. When dissolved iron is present in the amount indicated, chemical oxidation in step 120 is performed using one or more of the oxidants having an oxidizing potential less than about 2V (SRP) (box 220). The oxidized ion forms a solid hydroxide removed by the downstream processes described in further detail below.

In decision diamond 224, it is determined whether the stabilized produced water contains at least about 0.1 ppm sulfide ion. When sulfide ion is present in the amount indicated, a chemical additive such as lead nitrate, lead acetate, or any other suitable additive is added, typically during optional step 120, to convert the sulfide into lead sulfide (PbS_{(solid)}) (box 228). In decision diamond 232, it is determined whether immisicible organics are present in the stabilized produced water. Examples of immiscible organics include oil, grease, gel polymers, and emulsions. When present, immiscible organics are removed in step 132 by dissolved air flotation techniques (box 236). In decision diamond 240, it is determined whether suspended solids in an amount of at least about 2 ppm are present in the stabilized produced water. If so, the suspended solids are removed in step 132 using flocculants and dissolved air flotation (box 244). In decision diamond 248, it is determined whether the stabilized produced water contains miscible organic compounds. When present (typically in a concentration of at least about 0.001 ppm), the organic compounds are removed in step 144 using adsorbent media, such as one of the media described above (box 252). Finally, in decision diamond 256, it is determined whether any difficult-to-remove organic compounds are present (typically in a concentration of at least about 0.1 ppm). Examples of such organic compounds include guar gum and polyacrylamides. When present, such organic compounds are removed by intense oxidation, as in optional step 152 (box 260). In box 256, further produced water unit treatment operations are based on the selected end use for the purified water.

Referring now to FIG. 3, the logic starts with decision diamond 300, which asks whether the treated produced water, after being subjected to a selected set of unit operations in the process of FIG. 1, is suitable for the proposed end use. If so, the treated produced water is used without further treatment for the intended use (box 304). If the treated produced water is noncompliant, it is determined in decision diamond 308 whether the treated produced water contains suspended solids, miscible organic compounds, and/or Total-Petroleum-Hydrocarbon (TPH). Typically, the concentrations of one or all of these target materials is significant when it is at least about 10 ppm. When present in significant amounts, at least most of the target material is removed by one or more of microfiltration, ultrafiltration, or nanofiltration (box 312). In decision diamond 316, it is determined whether the TDS of the treated produced water is at least about 250 ppm. If so, at least most of the dissolved solids are removed using one or more of a nanofilter or a hyperfilter membrane (box 320). In decision diamond 324, it is determined whether the treated produced water has a dissolved chloride ion (Cl⁻) concentration of at least about 250 ppm. When present, at least most of the chlorine ion is removed using a hyperfilter membrane (box 328). In decision diamond 332, it is determined whether the treated produced water has a dissolved sulfate concentration of at least about 250 ppm. If so, at least most of the sulfate is removed using one or more of a nanofilter or hyperfilter membrane (box 336). In next decision diamond 340, it is determined whether the treated produced water includes a dissolved manganese ion concentration of at least about 2 ppm. When present, at least most of the manganese ion is removed using one or more of nanofiltration and hyperfiltration (box 344). In decision diamond 348, it is determined whether the treated produced water has a dissolved arsenic concentration of at least about 0.01 ppm. When present, at least most of the arsenic is removed using a hyperfiltration membrane (box 352). In decision diamond 356, it is determined whether the treated produced water has a dissolved nitrate concentration of at least about 10 ppm. When present, at least most of the nitrate is removed using a hyperfiltration membrane (box 360). Finally, in decision diamond 364, it is determined whether the treated produced water has a pH less than about pH 6.5 or greater than about pH 9. When the pH complies with one of these two conditions, the pH is adjusted to fall within the range of from about pH 6.5 to about pH 9 (box 368). The treated produced water is then sent to the proposed use (box 304).

Referring now to FIG. 4, the logic starts with decision diamond 300, discussed above. If the treated produced water is noncompliant, it is determined in decision diamond 400 whether the treated produced water contains suspended solids and/or miscible organic compounds. Typically, the concentrations of one or all of these target materials is significant when it is at least about 10 ppm. When present in significant amounts, at least most of the target material is removed by one or more of microfiltration, ultrafiltration, or nanofiltration (box 404). In decision diamond 408, it is determined whether the TDS of the treated produced water is at least about 250 ppm. If so, at least most of the dissolved solids are removed using one or more of a nanofilter or hyperfilter membrane (box 412). Next decision diamond 324 and associated box 328 were discussed above. In decision diamond 416, it is determined whether the treated produced water has a boron concentration of at least about 0.75 ppm. If so, the pH is adjusted in box 420 to be between about pH 10 and about pH 12, and, in box 424, at least most of the boron is removed using a hyperfilter membrane. Finally, in decision diamond 428, it is determined whether the treated produced water has a pH less than about pH 6.5 or greater than about pH 9. When the pH complies with one of these two conditions, the pH is adjusted to fall within the range of from about pH 6.5 to about pH 9. The treated produced water is then sent to the proposed use (box 304).

Referring now to FIG. 5, the logic starts with decision diamond 300 discussed above. If the treated produced water is noncompliant, decision diamond 400 and associated box 404 are performed. In decision diamond 500, it is determined whether the treated produced water includes one or more of dissolved calcium, aluminum, magnesium, and iron (typically in an amount of at least about 1 ppm). If so, it is determined in decision diamond 504 whether the treated produced water includes dissolved silica (typically in an amount of at least about 5). If the water does not include a significant amount of silica, at least most of the calcium, aluminum, magnesium, and/or iron is removed using one or more of a nanofilter and hyperfilter membrane (box 508). If the water includes significant amounts of silica, the pH of the treated produced water is adjusted, on box 512, to a pH in the range of about pH 6 to about pH 7, with pH 7 being preferred. The pH-adjusted treated produced water is then passed through one or more of a nanofilter or hyperfilter to remove at least most of the calcium, aluminum, magnesium, and iron (box 508). As will be appreciated, at least most of the silica will pass through the membrane when the water is in this pH range. Silica will thereby be separated from the calcium, aluminum, magnesium and iron. In decision diamond 516, it is determined whether the treated produced water includes a significant concentration of dissolved silica. A significant silica concentration is typically at least about 5 ppm. When a significant amount of silica is present, the pH of the treated produced water is pH adjusted in box 520 to a pH in the range of from about pH 9 to about pH 10, with pH 9being preferred. At least most of the silica is then removed by passing the pH-adjusted treated produced water through one or more of a hyperfilter or nanofilter (box 524). In decision diamond 528, it is determined whether the TDS of the treated produced water is at least about 6,000 ppm. If so, at least most of the dissolved solids are removed using one or more of a nanofilter or a hyperfilter membrane (box 532). In decision diamond 536, it is determined whether the treated produced water has a dissolved sulfate concentration of at least about 325 ppm. If so, at least most of the dissolved sulfate is removed using one or more of a nanofilter or hyperfilter (box 540). Finally, in decision diamond 544, it is determined whether the treated produced water has a pH less than about pH 6.5 or greater than about pH 9.5. When the pH complies with one of these two conditions, the pH is adjusted in box 548 to fall within the range of from about pH 7 to about pH 9.5, with a pH of about pH 9.5 being preferred. The treated produced water is then sent to the proposed use (box 304).

Using the logic of the above figures, a number of exemplary process configurations will now be discussed.

In a first process configuration, the produced water includes, as target materials, from about 2 to about 1,000 ppm insoluble or immiscible crude oil residuals (in the form of dispersed oil droplets) and at least about 2 ppm suspended solids (e.g., drilling mud).

The process configuration is a sequence of unit processes including: 1) aeration and/or aeration-with-shear to accelerate and/or complete the process of equilibration of the water to the given atmospheric conditions at the surface site; 2) coagulation and, optionally coagulation-flocculation, to remove at least most of the precipitated solids and solid-liquid emulsions newly formed by aeration, and to remove at least most of the solids, residual solids and polymer and oil contents of the water, the recovery typically being by way of either, or combinations of, flotation or settler thickening-decantation; 3) optionally, nanofiltration membrane treatment of the water for the removal of at least most of the dissolved hydrocarbons, multivalent dissolved solids species and artifact polymers and solids from the previous treatment step; and 4) optionally, the hyper-filtration treatment of the water to remove at least most of any remaining dissolved solids.

The first process configuration renders the water that is co-produced from the operation of oil and gas wells suitable for industrial reuse, for example, for reuse as a drilling or fraccing fluid, for use in managed irrigation, for use in aeroponics, hydroponics, aquacultural, or agricultural applications, or is rendered suitable for water supply use, for example for aquifer, surface impoundment or river storage for future recovery prior to further treatment by others to meet potable water disinfection and chlorination-fluoridation standards. All of these beneficial water uses are of undisputed economic value, and the first process configuration can solve a long-standing industrial problem of natural “produced water” waste by deep-well or evaporative disposal.

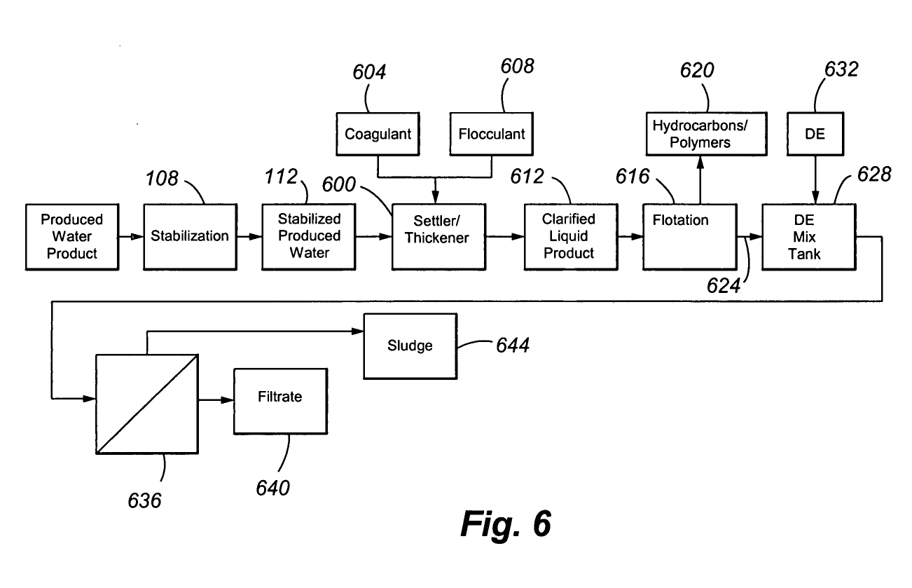

FIG. 6 shows one implementation the first process configuration in which the treated produced water provides an industrial water suitable for reuse in oil and gas field well “frac” stimulations. Produced water product is delivered to an aeration tank for stabilization 108 where air is sparged. During sparging, the solution is optionally shear agitated while monitoring the pH and ORP. Iron ions in the water oxidize when exposed to air. Even though the solution has some oxidation, it still needs to be stabilized by air injection. Aeration is performed with high shear until the solution reaches a stable pH and ORP. The aeration time depends on the type of aeration and high shear unit employed. For example, the time can be more than 24 hours for air exposure only (without sparging), as little as about 15 minutes when aeration is performed in a flotation cell with a high rpm impeller, and as little as about 45 minutes with air and a high rpm propeller. In one implementation, a coagulant is added during aeration in an amount ranging from about 0.5 to about 50 ppm, and even more preferably from about 5 to about 25 ppm. One suitable coagulant is available from Polymer Ventures and sold under the trade name HCD-44P, and is a low molecular weight, liquid cationic quaternary organic polymer coagulant. As will be appreciated, other suitable coagulants include, but are not limited to, aluminum sulfate, ferric sulfate, and lime.

The stabilized produced water 112 is then pumped to a settler-thickener 600 where coagulant 604 and, optionally, flocculant 608, are added to aid the formation and settler-thickener 600 bottom discharge of sludge (not shown) and to remove excess coagulant. The clarified liquid product 612 of the settler-thickener 600 is then gravity delivered to a flotation cell 616 where air is sparged and at least most, and preferably at least about 99%, of the floatable hydrocarbons, oils, greases and polymers 620 are overflow removed and underflow water 624 is pumped to a DE (Diamataceous Earth) mix tank 628 where DE 632 is added to the water 624 in an amount typically ranging from about 0.1 to about 1 wt.% to make a solid-liquid slurry typically ranging from about 0.1 to about 1% wt solids. The slurry is pumped to a particle filter 636 (which may be a DE precoated filter), where product water clear filtrate 640 and DE sludge 644 are produced. The filtrate 640 may be further treated by nanofiltration (not shown) to remove the dissolved hydrocarbons, multivalent dissolved solids species, artifact polymers, and solids and hyperfiltration (not shown) to remove any remaining dissolved solids. The retentate sludge 644, which includes at least most of the solid particles in the slurry, may be discarded by deep well injection.

In a second process configuration, water suited for agricultural and/or human water supply use is recovered from oil and gas field produced water. Agricultural and human use waters are also recovered from the polymer-laden, “flow-back fluid” contaminated produced water that episodically flows from a well after a well stimulation. Produced water is treated to remove a majority percentage of the miscible and immiscible hydrocarbon, suspended solid, dead and alive biological organism, and, polymer and remnants of polymers, contents of the produced water precedent to, optionally, an oxidation treatment of the water to reduce the total-organic-content of the water to approximately zero. This water treatment is followed, as required, by combinations of membranic ultrafiltration, nanofiltration, and hyper-filtration for the removal of residual colloids and dissolved inorganic solids.

The treatment of the stabilized flow back water may include, but is not limited to: 1) single or multiples-stage of oil-water separation by coalescer, flotation or flocculation for the removal of the bulk of the immiscible oil from the water; 2) aeration to stabilize the produced water; 3) biocide and iron oxidation by chlorine dioxide or another similarly potent oxidizing, biocide chemical; 4) ferric iron or other coagulating chemical addition to coalesce suspended solids, biocide detritus, and some of the flow back water polymer; 5) flocculation of the coagulated matters and thickening of the flocs for the production of a thickener overflow that contains residual miscible oil, immiscible oil, residual flow back water polymer and dissolved solids, and a thickener underflow that is pumped to a waste pond; 6) treatment of the thickener overflow by polypropylene fiber or nut shell filtration for the removal of essentially all of the residual immiscible oil and residual floc or suspended solids components the water, and some of the miscible oil and polymer content of the water; 7) treatment of the filtrate through an activated carbon polishing filter; 8) treatment of the carbon filter filtrate through a hydroxyl radical or oxygen radical oxidation reactor, as through a UV-TiO₂ photocatalytic hydroxyl radical generator, a UV-H₂O₂ hydroxyl radical generator, a high intensity, cavitating ultrasonic vibrator, or a UV-O₃oxygen radical generator, if required for the oxidation of residual flow-back water polymer; 9) the treatment of the UV treated water with oxygen scavengers to destroy residual oxidants; 10) the addition of anti-scalants; 11) treatment of the water by ultrafiltration to remove colloids and residual suspended solids; and 12) treatment of the water by nanofiltration and hyperfiltration membranes to produce a dissolved inorganic solids content elevated “brine” and a treated water permeate. Optionally, the eighth step in the process can be by a shear reactor O₃sparge precedent to the UV treatment. Also, where required, eighth step reagent additions need to be apportioned to the feed water total-organic-content of the water entering the sixth step process. Also, the product water of a reagent based eighth step needs to be monitored for, and mitigation steps developed to, decompose any excess eighth step reagent.

The second process configuration provides a water supply appropriate for human and/or agricultural use by recovering a purified produced water from stimulated well produced waters that are contaminated by polymers. The method of treatment requires the removal of miscible and immiscible oil and grease and suspended solids by oil separator and filtering devices, for example, oil separation by air flotation, by coalescence, by nut-shell filtration, by carbon filtration, by bedded-stacked media filtration, and suspended solids removal by deep-bed filtration, pressure filtration and/or bag, cartridge and bedded-stacked media bed filtration.

Also, conventional biocide treatment of the water would be performed as required to prevent the bio-fouling of any of the above described, or to be described, unit processes. The water that remains after the oil and suspended solids removal treatments, although clear and bright, retains the dissolved inorganic solids components of the water and residual polymer. The polymer (broken organic) is quantifiably measurable by a carbohydrate determination. Typically, at least about 90% of the polymers are decomposed into their oxide byproducts. The clear and bright water produced by conventional processes from a flow-back, frac polymer, broken organic, contaminated water is treated by a process of ferric sulfate or other coagulant flocculation and thickener, or other filtering device, removal. Pre- and postcoagulant treatment tests indicate these treatments to be from 50% -80% effective for the removal of carbohydrate.

Further, by the process of the second configuration, the residual frac polymer, broken organic that remains after coagulation and removal is subjected to oxidation by hydroxyl or oxygen radicals, the former being preferred, to reduce the polymer to its a elemental components (CO₂ and water). By the process of the second configuration, the method(s) of delivery of the oxidizing radicals is by UV-photocatalysis, by exposure to high intensity, ultrasonic radiation, by UV-H₂O₂ hydroxyl radical generation, or by Uv-O₃ oxygen radical generation. Furthermore, by the process of the second configuration, the water, cleaned of oils, greases, biota, suspended solids and broken polymer, is ultra-filtration treated to remove colloids, and nanofiltration and/or hyperfiltration membrane treated to separate the dissolved solids component of the water to a membrane process brine, and, conversely, a remaining portion of membrane process permeate water that is pure and suitable for either household or agricultural use. As required, the percent production of pure water can be optimized by the addition of antiscalant polymers that prevent, typically, calcium compound and silica scale formations.

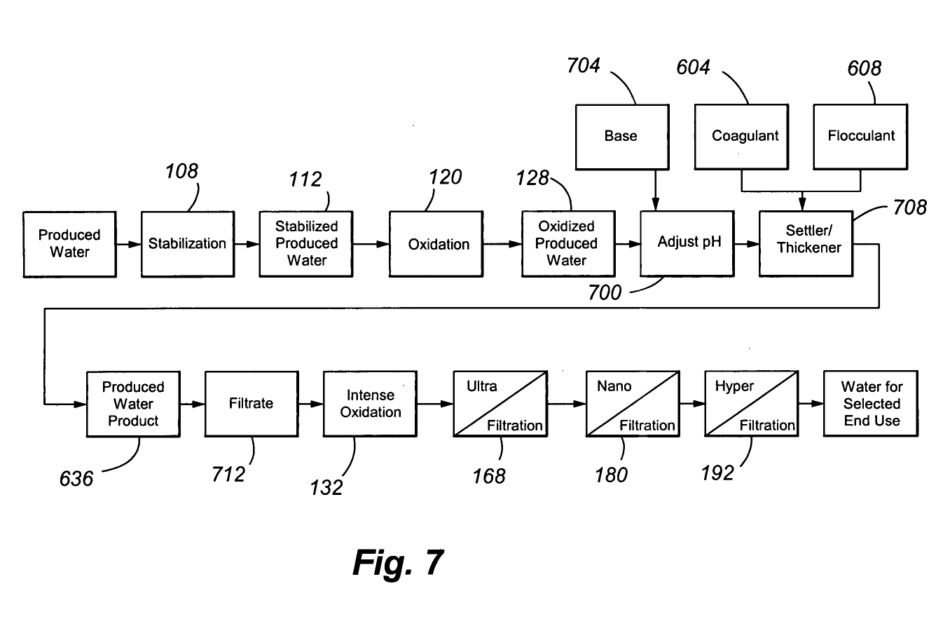

Referring now to FIG. 7, well-bore feed water 1 is first treated through an oil/water separator (not shown), and a discharge oil product (not shown) is skimmed from the top of the separator (not shown). The oil/water separator discharge water is stabilized 108, and the stabilized produced water 112 is oxidized 120 using the oxidant chlorine dioxide 5 or a similar oxidizing biocide. The water is treated with a ferric sulfate or other form of coagulant 604, and then optionally pH adjusted in step 700 using a base 704, such as lime or caustic or other similar pH adjustment chemical. The pH-adjusted water is then flocculant 608 treated and fed to a thickener 708. The flocs of coagulated matter are removed as thickener underflow. The thickener overflow water contains residual suspended solids and unrecovered floc, as well as miscible and immiscible oil, dissolved solids, and un-recovered “broken organic.” The thickener overflow is passed to an immiscible oil removal filter 636, or an immiscible and miscible oil removal filter, that coincidentally removes additional portions of suspended solids and floc.

The filtrate 712 is then subjected to intense oxidation 132 using peroxide and ozone oxidation pre-cursor chemicals in a mixing reactor, and the chemically treated solution is passed through an ultra-violet (UV) light or exposed to high intensity, ultrasonic radiation where such interaction with the peroxide and ozone molecules forms hydroxyl and oxygen radicals. The hydroxyl and oxygen radicals react with the carbon component of the “broken organic” in the water to form carbon dioxide. Optionally, the water is then antiscalant treated, as required, to prevent the formation of, typically, calcium and silica scale.

The treated water is then passed through a sequence of ultrafiltration 168, nanofiltration 180, and hyper-filtration 192 processes on an as-required basis for the removal of at least most of the colloids, multivalent ions and monovalent ions, respectively, to a process brine. The bulk of treated water that traverses the filtration steps is suitable for the selected end use.

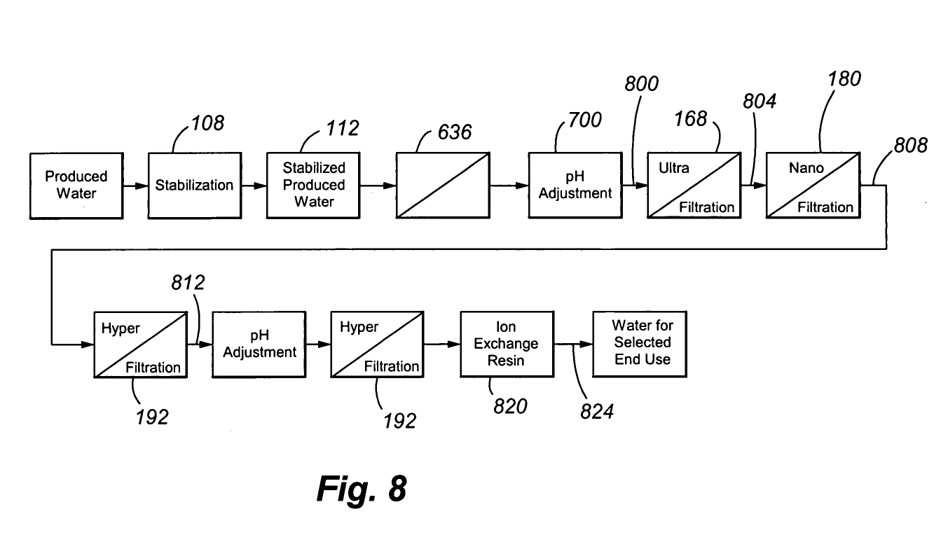

In a third process configuration of FIG. 8, steam stimulated oil field produced water is processed in approximately its “as-received” hot condition such that the bulk of the water is discharged at the quality required for the boiler generation of high-pressure steam. The water treatment processes of the third process configuration include, in order: (1) immiscible hydrocarbon recovery; (2) aeration to stabilize the produced water, (3) suspended solids, residual emulsion, and miscible long-chain hydrocarbon removal; (4) the membrane removal of miscible light fraction hydrocarbon and multivalent ions; (5) the membrane removal of monovalent ions; and (6) selective ion-exchange resin “polishing.” Depending on the dissolved solids contents of the water being treated, pH adjustments before, between or after any of the processing steps may be required. Depending on the geologic conditions of the production site, the pressurized wastewater brine generated by the ion separation stages of the process may be deep well injected using said pressure, or, where the pressure of the brine is insufficient to the completely deliver brine to the targeted brine disposal geologic formation, the pressure may be stage-pump boosted to effect brine disposal.

The third process configuration meets a long-standing water conservation need of the petroleum industry because steam stimulated petroleum production typically requires the injection of 10-15 barrels of water (converted to high pressure steam) per barrel of produced crude and the injected water, upon wellhead recovery, is hydrocarbon-contaminated and dissolved solids-contaminated. The high pressure steam injected into oil and gas fields stimulates hydrocarbon production by heat related viscosity modification, e.g., heat thinning of heavy oil or the oil component of tar sands. The injected steam condenses, dissolves formation minerals, commingles with formation liquids, and reports to production wellheads as “produced water.” The quality of produced water is poor, i.e., the water is unsuitable as boiler feed water for reuse or agricultural use and does not meet the water quality standards for discharge to surface waters.

In the third process configuration, the bulk of the water used for high pressure steam production for oil field stimulation is recovered for reuse. After stabilization, the process takes high temperature produced water through a series of oil skimming, suspended solids filtration, high pressure ion separation membrane treatment and ion-exchange polishing to produce high quality water suitable as boiler feed water for the production of high pressure steam in a manner that preserves the heat asset of the stream and, optionally, utilizes the pressure aspects of the membrane brine (i.e., minority component of the produced water feed stream that is not discharged at boiler feed water quality) as the first or only stage of a deep well brine disposal system.

In the third process configuration, “hot” SAG-D produced water (typically −185° F.) is:
1. Aerated until stable;
2. Skimmed for the recovery of immiscible oil by use of an API Settler, Dissolved Air Flotation Cell, or other gravity based or enhanced gravity oil separation (e.g., centrifuge) device, with coincidental solids (entrained dirt) recovery if the device promotes and/or accommodates the gravity segregation of the solids;
3. Followed by either a Dissolved Air Flotation or Low Pressure Membrane ultrafiltration separation of solids and residual emulsion with or without the use of emulsification and/or coagulation chemicals;
4. Followed by the removal of multivalent ions by High Pressure Membrane nanofiltration with or without the use of anti-scalent chemicals and/or a downward pH adjustment pre-treatment;
5. Followed by the removal of monovalent ions by single- or multiple-stage High Pressure Membrane reverse osmosis element filtration with or without upward or downward pH adjustments before, interstage or after the treatment; and
6. Followed by residual ion scavenging on a selective basis by ion-exchange resin.

The high pressure membrane steps in the process are typically in the range from about 200-1200 psi, and produce two (2 ea.) streams, a product water stream for downstream processing and a “brine” stream for disposal, typically by deep-well injection. Optionally, depending on depth of the aquifer into which the brine is to be injected and the rate of brine injection, the back-pressure throttle for the membrane system may be entirely supplied by the deep-well injection process flow resistance (back-pressure). Alternatively, if the geologic disposal stratum is too shallow or porous to supply the required back-pressure the membrane process can be artificially throttled. Alternatively, if the pressure required for deep-well disposal is beyond the pressure requirements of the membrane system, a series booster pump can be added to the brine discharge line to coincidentally induce the back pressure required for the operation of the membrane system and the deliver the brine under increased pressure to the disposal stratum.

Referring to FIG. 8, hot Steam Assisted Gravity Drainage (SAG-D) produced water is fed to an API Oil Separator (not shown) and crude oil (not shown) is recovered. The discharge from the API Separator is then fed to a secondary oil skimming Inert Gas Flotation device (IGF) (not shown) for the further production of oil from the top of the cell and suspended solids from the bottom. The discharge from the IGF is stabilized 108, and the stabilized water 112 fed to a solid-liquid separation filter 636, where at least most of the suspended solids are removed from the solution.

The filtrate from the solid-liquid separation device 636 is pH adjusted in step 700 before being passed through a low pressure membrane ultrafiltration device 192 for the removal of at least most of the remaining miscible oil and residual colloidal solids. The immiscible oil- and colloidal solids-containing retentate is typically about 5% or less of the ultrafiltration feed 800. The permeate discharge 804 from the ultrafilter is optionally dosed with an antiscalent to control the precipitation of calcium and barium compounds during nanofiltration 180. The permeate feed to the nanofilter is high pressure membrane processed to produce a multivalent ion and miscible oil brine that exits the process under pressure. Optionally, the pressurized brine 17 can be disposed down a deep well (deep well injected). The brine is typically about 10% of the permeate 804 feed to the nanofiltration process. The permeate 808 discharge from the nanofiltration process is fed to a high pressure membrane Reverse Osmosis process 192 to produce a monovalent ion loaded brine retentate that can optionally be disposed down a deep well (deep well injected) and a clear permeate 812. The brine from the first stage RO process is typically 15% of the permeate feed 808 to the process.

The clear permeate discharge 812 from the first stage RO process 192 is pH adjusted in step 700 and second stage high pressure membrane Reverse Osmosis 192 treated to produce a residual monovalent ion loaded brine that can optionally be disposed down a deep well (deep well injected) and a clear permeate 816 solution. The brine from a second stage RO process 192 is typically about 10% of the RO process permeate feed 812. The permeate discharge 816 from the 2nd stage RO process 192 may yet contain deleterious monovalent ions that can be scavenged from the solution by exposure to an ion selective resin ion exchange (IX) system 820. The deleterious ion loaded resin can be disposed of or stripped and regenerated. The discharge 824 from the IX 820 can optionally be pH adjusted (not shown) precedent to feed to boilers for the production of high pressure steam.

A number of variations and modifications of the invention can be used. It would be possible to provide for some features of the invention without providing others.

For example in one alternative embodiment, the various processes are not limited to waters from subterranean deposits but may be used to treat any process waters containing a suite of the identified target materials.

In another alternative embodiment, the various unit operations are rearranged in different orders and/or used discretely or in subsets of the unit operation sets depicted in the figures.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A water treatment method, comprising:
(a) providing a stabilization operation to aerate a selected feed water, the selected feed water having been withdrawn from a subterranean formation;
(b) when the selected feed water contains at least a first selected concentration of an emulsion, providing an oxidation operation to decompose at least a portion of the emulsions;
(c) when the selected feed water contains at least a second selected concentration of an immiscible organic compound, providing a macro-particle removal operation to remove at least a portion of the immiscible organic compound; and
(d) when the selected feed water contains at least a third selected concentration of a miscible organic compound, providing an adsorption operation to remove at least a portion of the miscible organic compound.

2. The method of claim 1, further comprising:
(e) when the selected feed water contains at least a fourth selected concentration of living microbes, providing for contact of a biocide with the selected feed water;
(f) when the selected feed water contains at least a fifth selected concentration of dissolved iron, providing the oxidation operation to reduce the dissolved iron to form an iron solid;
(g) when the selected feed water contains at least a sixth selected concentration of dissolved sulfide, providing for contact of at least one of a lead nitrate and a lead acetate with the selected feed water;
(h) when the selected feed water contains at least a seventh selected concentration of suspended solids, providing the flotation operation to remove at least most of the suspended solids; and
(i) when the selected feed water contains at least an eighth selected concentration of at least one of guar and polyacrylamide, providing a unit operation of intense oxidation to decompose at least most of the at least one of guar and polyacrylamide.

3. The method of claim 1, further comprising:
(e) when the selected feed water contains at least a fourth selected concentration of at least one of suspended solids, miscible organic compounds, and Total Petroleum Hydrocarbon (TPH), providing at least one of microfiltration, ultrafiltration, and nanofiltration to remove at least most of the at least one of suspended solids, miscible organic compounds, and TPH;
(f) when the selected feed water contains at least a fifth selected concentration of Total Dissolved Solids (TDS), providing at least one of nanofiltration and hyperfiltration to remove at least most of the TDS;
(g) when the selected feed water contains at least a sixth selected concentration of dissolved sulfate, providing at least one of nanofiltration and hyperfiltration to remove at least most of the manganese;
(h) when the selected feed water contains at least a seventh selected concentration of dissolved manganese, providing at least one of nanofiltration and hyperfiltration to remove at least most of the sulfate;
(i) when the selected feed water contains at least a eighth selected concentration of dissolved arsenic, providing hyperfiltration to remove at least most of the arsenic; and
(j) when the selected feed water contains at least a ninth selected concentration of dissolved nitrate, providing hyperfiltration to remove at least most of the nitrate.

4. The method of claim 1, further comprising:
(e) when the selected feed water contains at least a fourth selected concentration of dissolved chloride, providing hyperfiltration to remove at least most of the dissolved chloride; and
(f) when the selected feed water contains at least a fifth selected concentration of dissolved boron, providing hyperfiltration to remove at least most of the dissolved boron.

5. The method of claim 1, further comprising:
(e) when the selected feed water contains at least a fourth selected concentration of dissolved calcium, aluminum, magnesium, and iron, providing at least one of nanofiltration and hyperfiltration to remove at least most of the dissolved calcium, aluminum, magnesium, and iron while passing dissolved silica; and
(f) when the selected feed water contains at least a fifth selected concentration of dissolved silica, providing at least one of nanofiltration and hyperfiltration to remove at least most of the dissolved silica.

6. A treatment method, comprising:
(a) receiving a produced water from a subterranean formation, the produced water comprising at least one chemical constituent that is unstable at the surface;
(b) aerating the produced water with a molecular oxygen-containing gas until a selected degree of stability of the produced water has been realized; and
(c) thereafter further treating the produced water to remove one or more selected target materials.

7. The treatment method of claim 6, wherein the selected degree of stability is realized when a measured Oxidation-Reduction Potential (ORP) changes no more than about 10% in a selected time ranging from about 10 to about 20 minutes.

8. The method of claim 6, wherein the produced water comprises emulsions and wherein step (c) comprises the substeps:
(c1) further oxidizing at least a portion of the produced water to decompose substantially emulsions; and
(c2) removing, from at least a portion of the produced water, at least most of any suspended solids and immiscible organic materials.

9. The method of claim 6, wherein the produced water comprises at least one of guar and polyacrylamide and wherein step (c) comprises the substep:
(c1) contacting the at least one of guar and polyacrylamide with a hydroxyl radical to decompose the at least one of guar and polyacrylamide.

10. The method of claim 6, wherein the produced water comprises living microbes, immiscible organic materials, and miscible organics and wherein step (c) comprises the substeps:
(c1) contacting at least a portion of the produced water with a biocide agent to kill at least most of the microbes;
(c2) subjecting at least a portion of the produced water to flotation to remove at least most of the immiscible organic materials; and
(c3) adsorbing at least most of the miscible organics in at least a portion of the produced water onto a microporous substrate.

11. The method of claim 6, wherein the produced water comprises a plurality of target materials and wherein step (c) comprises the substeps:
(c1) subjecting at least a portion of the produced water to ultrafiltration to remove a first subset of target materials;
(c2) thereafter subjecting at least a portion of the produced water to nanofiltration to remove a second subset of target materials; and
(c3) thereafter subjecting at least a portion of the produced water to hyperfiltration to remove a third subset of target materials.

12. A treatment method, comprising:
(a) receiving an aqueous feed derived from extracting hydrocarbons from a subterranean formation;
(b) first mildly oxidizing the aqueous feed to decompose any emulsions in the aqueous feed, wherein the mildly oxidizing step uses a chemical oxidant having an oxidizing potential of no more than about 2V (SRP);
(c) thereafter intensely oxidizing at least a portion of the aqueous feed to decompose a selected organic material, the intensely oxidizing step using a chemical oxidant having an oxidizing potential of more than about 2V (SRP); and
(d) further treating the aqueous feed after step (c).

13. The method of claim 12, wherein the aqueous feed is produced water and wherein step (a) comprises the substeps:
(a1) receiving the produced water from a subterranean formation, the produced water comprising at least one chemical constituent that is unstable at the surface; and
(a2) aerating the produced water with a molecular oxygen-containing gas until a selected degree of stability of the produced water has been realized, wherein the selected degree of stability is realized when a measured Oxidation-Reduction Potential (ORP) of the produced water changes no more than about 10% in a selected time ranging from about 10 to about 20 minutes.

14. The method of claim 12, wherein the aqueous feed comprises at least one of guar and polyacrylamide and wherein, in the intensely oxidizing step, the at least one of guar and polyacrylamide is contacted with a hydroxyl radical to decompose the at least one of guar and polyacrylamide.

15. The method of claim 14, wherein the hydroxyl radical is generated by contacting the aqueous feed with ultrasonic radiation.

16. The method of claim 14, wherein the hydroxyl radical is generated by contacting the aqueous feed with ultraviolet radiation in the presence of at least one of ozone and hydrogen peroxide.

17. The method of claim 12, wherein the produced water comprises a plurality of target materials and wherein step (d) comprises the substeps:
(d1) subjecting at least a portion of the aqueous feed to ultrafiltration to remove a first subset of target materials;
(d2) thereafter subjecting at least a portion of the aqueous feed to nanofiltration to remove a second subset of target materials; and
(d3) thereafter subjecting at least a portion of the aqueous feed to hyperfiltration to remove a third subset of target materials.

18. A treatment method, comprising:
(a) receiving an aqueous feed derived from extracting hydrocarbons from a subterranean formation;
(b) intensely oxidizing at least a portion of the aqueous feed to decompose a selected organic material, the intensely oxidizing step using a chemical oxidant having an oxidizing potential of more than about 2V (SRP); and
(c) further treating the aqueous feed after step (b).

19. The method of claim 18, wherein step (a) comprises the substep:
(al) mildly oxidizing the aqueous feed to decompose any emulsions in the aqueous feed, wherein the mildly oxidizing step uses a chemical oxidant having an oxidizing potential of no more than about 2V (SRP).

20. The method of claim 18, wherein the aqueous feed is produced water and wherein step (a) comprises the substeps:
(a1) receiving the produced water from a subterranean formation, the produced water comprising at least one chemical constituent that is unstable at the surface; and
(a2) aerating the produced water with a molecular oxygen-containing gas until a selected degree of stability of the produced water has been realized, wherein the selected degree of stability is realized when a measured Oxidation-Reduction Potential (ORP) of the produced water changes no more than about 10% in a selected time ranging from about 10 to about 20 minutes.

21. The method of claim 18, wherein the aqueous feed comprises at least one of guar and polyacrylamide and wherein, in the intensely oxidizing step, the at least one of guar and polyacrylamide is contacted with a hydroxyl radical to decompose the at least one of guar and polyacrylamide.

22. The method of claim 18, wherein the hydroxyl radical is generated by contacting the aqueous feed with ultrasonic radiation.

23. The method of claim 18, wherein the hydroxyl radical is generated by contacting the aqueous feed with ultraviolet radiation in the presence of at least one of ozone and hydrogen peroxide.

24. A system for treating an aqueous feed, comprising:
(g) an aeration vessel to contact the aqueous feed with a molecular oxygen-containing gas;
(h) a flotation vessel located downstream of the aeration vessel to remove, from at least a portion of the aqueous feed, a first set of immiscible organic target materials;
(i) a clarifier located downstream of the flotation vessel to remove, from at least a portion of the aqueous feed, suspended solids;
(j) an absorbent located downstream of the flotation vessel to remove a second set of miscible organic target materials;
(k) at least one of a microfilter and ultrafilter located downstream of the absorbent to remove, from at least a portion of the aqueous feed, a third set of target materials; and
(l) at least one of a nanofilter and hyperfilter located downstream of the at least one of a microfilter and ultrafilter to remove, from at least a portion of the aqueous feed, a fourth set of target materials.

25. The system of claim 24, further comprising:
(g) an oxidation vessel, positioned between the aeration vessel and flotation vessel, to decompose any emulsions in at least a portion of the aqueous feed.

26. The system of claim 24, wherein the at least one of a microfilter and ultrafilter includes a microfilter positioned upstream of an ultrafilter.

27. The system of claim 24, wherein the at least one of a nanofilter and hyperfilter includes a nanofilter positioned upstream of a hyperfilter.

28. The system of claim 24, further comprising:
(g) an intense oxidation vessel, positioned between the absorbent and the at least one of a microfilter and ultrafilter, to decompose selected organic materials, the intense oxidation vessel including at least one of an ultrasonic and ultraviolet radiation source to irradiate at least a portion of the aqueous feed and generate free hydroxyl radicals.
